(19) United States
(12) Patent Application Publication
(10) Pub. No.: US 2009/0110843 A1
(43) Pub. Date: Apr. 30, 2009

(54) Thermosetting ink formulation for ink-jet applications

(76) Inventors: Izhar Halahmi, Hod-Hasharon (IL); Shalom Luski, Rehovot (IL); Michal Cohen, Rehovot (IL)

Correspondence Address: THE NATH LAW GROUP, 112 South West Street, Alexandria, VA, 22314, US

(21) Appl. No.: 11/990,513

(22) PCT Filed: Aug. 17, 2006
(86) PCT No.: PCT/IL2006/000959

§ 371 Date: Jul. 24, 2008

Related U.S. Application Data
(60) Provisional application No. 60/708,791, filed on Aug. 17, 2005.

(51) Int. Cl. B05D 5/06; C09D 11/10

(52) U.S. Cl. 427/511; 524/88; 525/397; 525/390; 524/538; 524/541; 524/540; 524/190; 524/93; 524/420; 427/256

(57) ABSTRACT

The present invention discloses a latent thermosetting ink formulation for ink jet applications comprising a phenolic resin, an amino resin and a polyol. The formulation is characterized as having a viscosity of lower than 50 Cps at a shear rate of 10 to 100,000 sec-1 at a temperature lower than 100 C and a surface tension lower than 40 dynes/cm.

### FIELD OF THE INVENTION

This invention relates to ink formulations suitable for ink-jet printing.

### BACKGROUND OF THE INVENTION

Ink-Jet inks are special liquids that are applied by ink-jet printers as discrete droplets onto a substrate. The ink-jet technology, in comparison with other conventional printing technologies, allows the formation of an image without the need of screens and photo masks and the application of the ink only when drop is required (drop-on-demand). The result is thus cost effective and presents a high degree of flexibility from the user standpoint.

Ink jet methodologies have been widely adopted for industrial marking, office printing (of both text and graphics), signage in display graphics (e.g., photographic reproduction, business and courtroom graphics, graphic arts), and the like for numerous reasons. One important reason is the ease of operation and great versatility in terms of the variety of substrates that can be treated, as well as the print quality and the speed of operation that can be achieved.

The ink-jet printing process involves the ejection of fine droplets of ink onto a print medium (the substrate), typically in response to electrical signals generated by a microprocessor. Typically, an ink-jet printer utilizes plurality of printing heads mounted on a carriage that is moved relative to the surface of the substrate or static heads on a bridge and moving substrate.

The printing heads typically include orifice plates that have very small nozzles (typically 10-50 μm diameter) through which the ink droplets are ejected. Adjacent to these nozzles are ink chambers where ink is stored prior to ejection. The mechano-acoustic nature of the printing heads requires that the ink viscosity be kept in the range of about 8-14 Cps at the jetting temperature and the surface tension of the ink should be kept in the range of about 26-34 dynes/cm. If, for example, the viscosity and/or the surface tension fall outside of the optimal parameters, the printing quality may be affected.

Ink jet methodologies have found use in a great number of versatile applications, ranging from the application of ink formulations for the purpose of printing to the depository of biological material for biological applications. One of the great number of publications which disclose or report on the vast variety of ink-jet formulations known to date is US application no. 2005/0171237. This application discloses a fully curable jettable composition having a viscosity of less than 30 cps at a temperature within the range of 15 to 180° C. This composition comprises (A) at least one low viscosity reactive resin having a molecular weight not grater than 300 Daltons and a viscosity at a temperature in the said range of less than 30 cps; (B) at least one higher viscosity resin having a viscosity twice as larger as the low viscosity resin at the same temperature; (C) at least one curable toughener; (D) at least one initiator for the polymerization of the resins; and (E) at least one stabilizer for the delaying the curing of the resins of the composition.

Ink-jet inks for the PCB industry are unique formulations that not only need to meet the chemical and physical characteristics required of ink-jet formulations, but also need to meet the requirements of the PCB industry, e.g., chemical resistance against process media, assembly processes and long-term durability of the assembled board. One specific use of the formulations is as marking inks (legend), which are applied onto the bare board or metal conductors and pads or the solder mask coated board, in order to accurately mark the placement of components, or add serial numbers, barcodes or trademarks.

Current legend inks are based on UV curable acrylates, but these inks provide insufficient thermal, chemical and physical stability.

There has been a constant need, from the industrial standpoint, for such an ink-jet formulation for the PCB industry which would balance between the chemical and physical characteristics required of ink-jet formulations and the prerequisites of the PCB industry, both in term of resistance to various industrial processes and in term of the industrial requirement of color.

### SUMMARY OF THE INVENTION

The inventors of the invention disclosed in the present application have successfully developed an ink formulation (herein referred to interchangeably as “the ink formulation”, “the ink”, or “the formulation of the invention”) which comprises a novel combination of a phenolic resin, an amino resin and at least one hydroxyl-containing compound (referred hereinafter as Polyol), and optionally catalysts, one or more pigment or dye, organic solvent, wetting and dispersing agents and inorganic filler.

This novel formulation exhibited (a) the suitable viscosity and surface tension to be applied by an ink-jet printer at jetting temperatures from ambient to about 100° C. (degrees Celsius), (b) the suitable latency so its viscosity remains unchanged for prolonged time when stored at temperatures of ambient or lower, (c) after being printed on e.g., printed circuit boards (PCB or PWB) and thermally cured at temperatures from 120° to 200° C. has a balanced cross-linking density and backbone chemical nature to survive the chemical and thermal stresses related to the harsh environment related to printed circuit board manufacturing, and (d) has the neutral color, to enable pigmentation to almost any color and shade, so as to permit the use of the ink formulations to various other applications such as legend marking of PCB.

Thus, in a first aspect of the present invention, there is provided a thermosetting ink formulation comprising at least one phenolic resin, at least one amino resin and at least one polyol, said formulation being latent.

In one embodiment of this aspect of the invention, the formulation is highly latent.

The term “thermosetting ink” as used herein refers to an ink comprising monomers and/or oligomers and/or polymers in the uncured fluid state, thus having the capability of being transformed into a three-dimensional network after cross-linking, which is induced by heat and/or by actinic radiation. The three-dimensional network thus becomes an insoluble solid having no capability of re-melting.

In another embodiment, said formulation is characterized as having a viscosity lower than 50 Cps at a shear rate of 10 to 100,000 sec⁻¹ measured at a temperature lower than 100° C. and a surface tension lower than 40 dynes/cm at the same temperature.

The formulation is also characterized by the color of the print after complete curing, namely by the color of the print which results from e.g. the ink-jet printing thereof on a substrate, as will be defined hereinbelow, and the thermal curing of said print at a temperature from 120° to 200° C. The color of the cured print will depend on the pigment or dye used. For example, the color of the un-pigmented ink formulation after complete curing, ranges from clear to light yellow at various curing temperatures ranging from 120 to 220° C. The formulation may be pigmented by the addition of at least one pigment or dye in order to afford a cured print of a different color.

In a preferred embodiment, the formulation of the present invention is pigmented by a white pigment, affording a cured print having a color varying from white to light yellow, the color range accepted by the PCB industry, especially as legend (marking) ink.

In another embodiment, the formulation of the present invention comprises a pigment of a non-white color, affording a cured print having a non-white color (e.g., red, green, blue and in any shade thereof).

The “Amino resins” are amine-based reactive compounds which are selected from melamine monomer or polymer, melamine-formaldehyde resins, benzoguanamine-formaldehyde resins, urea-formaldehyde resins, glycoluril-formaldehyde resins, triazine based amino resin and combinations thereof.

The “phenolic resins” are phenol-based resins which are selected from phenol aldehyde condensates (known as Novolak resins) including hydrogenated grades thereof, homopolymers and copolymers of alkenyl phenols including hydrogenated grades thereof, poly(vinyl phenol) resins including co-polymers thereof with other unsaturated monomers such as styrene, acrylic or methacrylic acid and esters thereof, and including hydrogenated grades of said resins, polymers comprising phenolic units and non-aromatic cyclic alcohol units including hydrogenated grades thereof, and homo-polymers and co-polymers of N-hydroxyphenyl-maleimides.

More specifically, a subgroup of phenolic resins are etherified phenol resins—especially etherified phenol formaldehyde or cresol formaldehyde grades which are more latent, less viscous, more ductile and have clear-light color after curing. Another class of potential phenol resins is polyvinyl phenol polymers including co-polymers thereof with other unsaturated monomers such as styrene, acrylic or methacrylic acid and esters thereof, and including hydrogenated grades of said resins.

The phenolic resin is typically one which is light yellow in color or has a water-clear color before curing. Phenolic resins are reactive to primary and secondary aliphatic OH groups, as well as with themselves (self-condensation) and with epoxy (oxirane groups). This reaction is typically catalyzed by acids.

The term “polyol” refers to any compound, selected in non limiting manner from aliphatic, aromatic, heterocyclic, alicyclic and silicon containing compounds, having at least one hydroxyl (OH) group bonded thereto. The hydroxyl group is one capable of reacting with said amino resin and phenolic resin, as will be discussed hereinnext.

The polyol is most preferably a low molecular weight monomer or oligomer, characterized by molecular weight lower than 5,000 Dalton, more preferred less than 2,000 Daltons. The polyol may also contain inorganic atoms such as sulfur, phosphor, nitrogen, halogens, silicone, zirconium or combinations thereof.

Preferably, said polyol contains at least 1 hydroxyl group; more preferably, said polyol has at least two hydroxyl groups; even more preferably, said polyol consists of between 2 and 20 hydroxyl groups.

When specifying a certain or generic polyol having, for example, at least 2 hydroxyl groups, a reference is made to a polyol having 2 or more hydroxyl groups per every one molecule of polyol. For example, there may be 2 hydroxyl groups per molecule, 2, 3, 4, 5, 6, 7, 8, 9, 10, 11, 12, 13, 14, 15, 16, 17, 18, 19, 20, 30, 50 or more hydroxyl groups per polyol molecule or any other number of hydroxyl groups per a single molecule of polyol.

In one preferred embodiment, the polyol has an OH equivalent weight lower than 600, namely the molecular weight of the polyol divided by the average number of reactive hydroxyl groups contained in said polyol is lower than 600.

Non-limiting examples of the polyols are diglycidyl ether of bisphenol A (DGEBA), diglycidyl ether of bisphenol F (DGEBF), diglycidyl ether of bisphenol S (DGEBS), phenoxy resins manufactured by InChem, cycloaliphatic polyols such as cyclohexane dimethanol (for example the diol UNOXOL manufactured by DOW) or ethoxylates thereof, ethoxylated or propoxylated polyhydric alcohols (for example BOLTRON polyols and ethoxylated pentaerythritol by Perstrop) and heterocyclic based polyols, copolymers of unsaturated aromatic monomer, such as styrene and hydroxyl containing unsaturated monomer, for example Styrene-Allyl alcohol copolymers manufactured by Lyondell Corporation under the brand name SAA.

Another family of high functionality polyols is the group of polyols manufactured by free radical, anionic or cationic copolymerization of unsaturated hydroxyls containing compound with unsaturated monomers such as styrene, acrylic and methacrylic esters, allyl ethers, vinyl monomers and maleic anhydride or its derivatives.

The polyol is additionally characterized as having (a) good solubility in ketones, esters, carbonates and ether solvents; (b) at least one primary or secondary aliphatic OH group; (c) high hydrolytic and oxidative stability; (d) good reactivity with amino and phenolic resins; and (e) light in color.

The hydroxyl groups may be primary or secondary. The polyols may contain only primary, only secondary or a combination of primary and secondary hydroxyl groups. Most preferred are aliphatic hydroxyls, which are more reactive than aromatic ones.

In another embodiment, the ratio of the sum of the moles of said reactive groups in said phenolic resin and said amino resin to the sum of moles of hydroxyl groups on said polyol and other non volatile hydroxyl containing compounds present in the formulation of the invention, is greater than 1.5.

In yet another embodiment, the mass ratio of said amino resin to said phenolic resin is in the range of 0.01 to 100.

In still another embodiment, the thermosetting ink comprises said amino resin in a preferred amount of between about 1 and 40%, more preferably in an amount between about 1 and 25%, and most preferably between about 1 and 15% of the total weight of the formulation.

The formulation further comprises said phenolic resin in a preferred amount of between 1 and 40%, more preferably 1 and 20%, and most preferably between about 1 and 8% of the total weight of the formulation.

The formulation further comprises said polyol in a preferred amount of between 1 and 40%, more preferably between about 1 and 20%, and most preferably between about 1 and 15% of the total weight of the formulation.

The formulations of the invention may further comprise at least one pigment and/or dye selected in a non limiting manner from titanium dioxide, zinc sulfide, carbon black, Cu-phthalocyanine, benzimidazolone, azo pigments, and metallic pigments, preferably in an amount between about 1-60%, more preferably between about 1-50% and most preferred between about 1-40% of the total weight of the formulation. The average particle size of said pigment is of at most 2 microns.

The weight ratio between said pigment to said organic non-volatile matter in the cured print is in the range of 0.05 to 10.

Preferably, the pigment is titanium dioxide. The titanium dioxide may be in the pure form, as part of a mixture, coated by organic polymers or inorganic salts and/or oxides, or in any other presentation which may be suitable for the application.

In a specific case, said titanium oxide is a stabilized titanium dioxide in the form of particles, having titanium dioxide core and thin coating of alumina or alumina/silica or alumina/silica/zirconia, for example the grades Ti-Pure R-105 manufactured by Du-Pont and Kronos 2310 manufactured by Kronos.

The formulations of the invention may optionally further comprise at least one filler selected in non limiting manner from calcium carbonate, silica, talc, barium sulfate and kaolin. The average particle size of said filler is of at most 5 microns, more preferably of at most 2 microns and most preferably of at most 1 microns. The filler is present in the formulation in an amount that may range from 0 to 60%, more preferably from about 1 to 50% and most preferably from about 1 to 40% of the total weight of the formulation.

In another embodiment, the ink formulation further comprises at least one wetting agent (a surfactant) that assists the dispersion of the pigments and fillers and promotes wetting of the substrate with said ink formulation. The wetting agent may be selected in a non limiting manner from non-ionic surfactants, anionic surfactants and cationic surfactants. In a preferred embodiment, said wetting agent is selected from fluoro-surfactants, such as ZONYL manufactured by Du-Pont, silicone-surfactants, such as BYK 333 polyether modified poly dimethyl siloxane manufactured by BYK-CHEMIE and polyacrylate-surfactants such as BYK 353 manufactured by BYK-CHEMIE.

In yet another embodiment of the invention, the formulation comprises at least one dispersing agent (dispersants) selected from low molecular weight dispersants, capable of penetrating into agglomerates of said pigments and fillers and thus lower the attraction forces between particles and high molecular weight dispersants that prevent re-agglomeration.

In yet another embodiment of the invention, the formulation comprises at least one low molecular weight dispersing agent at 1-50% of the total weight of said fillers and pigments or dyes and at least one high molecular weight dispersing agent at 1-100% of the total weight of said fillers and pigments or dyes.

For example the low molecular weight dispersant may be DISPERBYK 110 and 111 acidic copolymers manufactured by BYK-CHEMIE and the high molecular weight dispersants may be DISPERBYK 161 and 163 copolymers manufactured by BYK-CHEMIE.

In still a further embodiment, the formulation further comprises at least one organic solvent, preferably in quantities ranging from between about 5 and 60%, more preferably from between about 1 and 50%, and more preferably from between about 1 and 30% of the total weight of the formulation. The solvent should have medium to low volatility to avoid pre-mature drying of ink in the ink-jet nozzles, surface tension in the range of 20 to 55 dynes/cm and viscosity of at most 20 Cps at ambient temperatures. Preferred solvents are selected from ethers, alcohols, glycols, lactones, cyclic esters and cyclic amides esters, ether-esters, alkyl carbonates, ketones, aromatic, aliphatic, amide, aliphatic, cycloaliphatic, silicon atom containing solvents, and combinations thereof. Specific solvents are, for example, Dowanol PMA and Dowanol DPM manufactured by DOW, propylene carbonate, triethylene glycol dimethyl ether, Solvesso 150 manufactured by ExxonMobil, gamma-Butyrolactone, and NMP (N-methyl-2-pyrrolidone).

In one particular embodiment, the thermosetting ink formulation of the invention comprises (w/w of total ink):

1. between about 1-40% of at least one amino resin;

2. between about 1-40% of at least one phenolic resin;

3. between about 1-40% of at least one polyol;

4. between about 1-60% of at least one pigment;

5. between 0 and 60% of at least one mineral filler; and

6. between about 5 to 60% of an at least one organic solvent.

In another embodiment of the present invention, the formulation further comprises between about 0.1-10% of the weight of the formulation of at least one oligomer or polymer, having an acid number greater than 50 mg KOH/gr, more preferred greater than 100 mg KOH/gr and most preferred greater than 120 mg KOH/gr. The “acid number” refers to milligrams of KOH required to neutralize all the acidic constituents present in a 1-gram sample of a tested compound.

The acidic groups bonded to said at least one oligomer or polymer are preferably selected from carboxyl, organic anhydrides, phosphoric ester derivatives and combination thereof. One group of preferred oligomers are the weakly acidic oligomers or polymers which are on one hand capable of catalyzing cross-linking of said amino and/or phenolic resin and hydroxyl groups at elevated temperatures, e.g. above 120° C., and on the other have adhesion promoting properties.

The weakly acidic oligomers or polymers are preferably selected in a non limiting manner from (a) acrylic or methacrylic acid co-polymers with other unsaturated monomers such as styrene, (b) maleic acid or anhydride copolymer with other unsaturated monomers such as styrene (for example styrene-maleic anhydride copolymer) graft polymers wherein the graft group is selected from carboxylic acids or anhydrides thereof, polymers comprising phosphoric group and esters thereof, such as the additive ADDITOL XL 180 manufactured by Solutia, and unsaturated polycarboxylic resins characterized by dual functionality, such as Sarbox SB500E 50 manufactured by Sartomer.

In another embodiment of the present invention, the formulation further comprises between about 0.01-10% of the weight of the formulation, of at least one blocked strong acid catalyst having high latency at ambient and high degree of catalysis of the cross-linking of said phenolic resin, amino resin and hydroxyl groups at temperature above about 120° C. The blocked catalyst is a salt, ester, amide, adduct, complex or any labile derivative of strong acid, wherein the blocking arrests the activity of the strong acid until such a point when the blocked acid is converted into the free acid form, thus allowing the acid to catalyze the reaction.

The at least one blocked catalyst is selected in a non limiting manner from blocked triflic acid, blocked sulfonic acid derivatives for example blocked para-toluenesulfonic acid (PTSA), blocked dodecylbenzenesulfonic acid (DDBSA), blocked dinonylnaphthalenedisulfonic acid (DNNDSA), blocked dinonylnaphthalene sulfonic acid (DNNSA), phosphates and phodphonates and antimony fluorides.

In yet still another embodiment of the invention, the formulation further comprises at least one hydroxyl-group containing unsaturated monomer. Preferably, the formulation comprises between about 1-20% of said hydroxyl group containing unsaturated monomer, which preferably contains at least one vinyl, allyl, acryl, methacryl or fumaryl group or any reactive C—C double bond which is reactive under free radical, anionic or cationic initiation conditions as terminal groups, side groups or as part of the main chain of said compound. The monomer also contains at least one primary or secondary hydroxyl group.

Non limiting examples of said hydroxyl containing unsaturated monomer are acrylated and methacrylated pentaerythritol derivatives, acrylated and methacrylated glycerol, acrylated and methacrylated trimethylol propane and acrylated and methacrylated DGEBA, unsaturated polyesters, hydroxyethyl methacrylate, hydroxyl alkyl acrylate, allyl alcohol propoxylate, allyl ethers and esters of polyhydric alcohols such as allyl ethers of trimethylol propane or pentaerythritol or glycerol.

The introduction of said OH containing unsaturated monomer enables compatibility between said ink and additional unsaturated monomers selected in non limiting manner from acrylic acid and methacrylic acid derivatives such as isobornyl acrylate or methacrylates, esters of short polyols and polyhydric alcohols with acrylic acid and methacrylic acid, urethane acrylate, ester of tris-2-hydroxyethyl isocyanurate (THEIC) with acrylic acid and methacrylic acid, esters of cycloaliphatic diols and polyols with acrylic acid and methacrylic acid, high functionality polyacrylate, allyl ether, allyl esters and especially diallyl phthalate and triallyl isocyanurate, allyl pentaerythritol and triallyl cyanurate.

The acrylates and allyl monomers (refer hereinafter as unsaturated monomers), in the presence of a photoinitiator and in response to light, provide the ink formulation of the present invention with an increased viscosity, a property which is important for print quality control.

The formulation, thus, in addition to all other disclosed additives, comprise at least one photoinitiator. Preferably, the formulation comprises between about 0.1-20% of at least one photoinitiator for initiating a cross linking between said unsaturated monomers, by a UV and/or light initiated free radical mechanism.

Non-limiting examples of radical photoinitiators to initiate photo curing of said unsaturated monomers are anthraquinone and derivative thereof, acetophenones, 1-hydroxy cyclohexyl-phenylketone and 2-methyl-1-(4 methylthio) phenyl-2-morpholin-propan-1-one; thioxanthones; ketals such as acetophenone dimethylketal and dibenzylketal; benzoins and benzoin alkyl ethers such as benzoin, benzyl benzoin methyl ether, benzoin isopropyl ether and benzoin isobutyl ether; azo compounds such as azobisisovaleronitrile; benzophenones such as benzophenone, methylbenzophenone, 4,4-dichlorobenzophenone, 4,4-bis-diethylamino benzophenone, Michler's ketone and xanthones, including mixtures thereof.

Important commercial initiators and synergists are Speedcure™ ITX, EHA and 3040, Irgacure™ 184, 369, 907 and 1850 and Darocure™ 1173.

The formulation may also, in addition to all other disclosed additives, or in place of one or more thereof, comprise at least one photoinitiator capable of generating cationic radicals in response to exposure to UV and/or visible light. The said photoiniotiator providing cationic radicals catalyzes the reaction between said phenolic resin, amino resin and the hydroxyls groups.

Non-limiting examples of cationic photoinitiators is triarlsulphonium (TAS) and diaryliodonium (DAI) salts, oxime sulfonate, triarylsulfonium and diazonium salts.

The present invention further provides thermosetting formulations having the constituents of any one of the formulations disclosed in any one of the Examples provided hereinbelow.

In another aspect of the present invention there is provided a thermosetting ink formulation having a viscosity lower than 50 Cps at a shear rate of 10-100,000 sec⁻¹ at a temperature lower than 100° C. and a surface tension lower than 40 dynes/cm under same temperature.

The formulations of the present application are suitable for ink-jet printing applications.

In another aspect of the present invention, there is provided a method for manufacturing the ink formulations of the present invention, said method comprises:

(i) mixing at least one amino resin and at least one polyol and at least one phenolic resin, until a clear solution is obtained; said at least one amino resin, polyol or phenolic resin are as defined hereinabove;

(ii) providing at least one pigment into said clear solution of step (i);

(iii) optionally providing at least one filler into said solution of step (i);

(iv) dispersing the mixture of step (ii and iii) by means of high shear mixer;

(v) milling the dispersed mixture of step (iv) until at least 90% of the mixture is able to pass through a 2− or less micron filter; and

(vi) adjusting the viscosity and surface tension of the filtered formulation of step (iv) by adding additional solvents, thus obtaining the desirable thermosetting ink formulation.

In one embodiment of the above method, at least one solvent, and/or wetting agent, and/or dispersing agents, and/or adhesion promoter, and/or inhibitor are added in step (i). In another embodiment, said phenolic resin is provided into said mixture after the step of milling, so as to minimize discoloration of the ink formulation during high shear milling.

In yet another embodiment, in step (v) of the method, other heat sensitive agents may be added. These may be selected from one or more of the following: initiators, e.g. photoinitiators, catalysts, unsaturated reactive compounds, hydroxyl comprising unsaturated compounds, and combinations thereof.

In another embodiment, the invention provides a master-batch or a concentrate comprising a selection of any of the ingredients of the formulation of the present invention. For example, the batch may be prepared by milling at least one pigment with at least one of the other ingredient of the formulation to afford the concentrate. Any such combination is possible. The master batch or concentrate may thus be stored as such and added to the remaining ingredients to provide the claimed formulations.

In yet another aspect of the present invention there is provided a thermosetting ink formulation obtained by the method of the present invention. In one embodiment of this aspect of the invention, said thermosetting ink formulation has a viscosity lower than 50 Cps at a shear rate of 10-100,000 sec⁻¹ at a temperature lower than 100° C. and a surface tension lower than 40 dynes/cm at said temperature.

In still another aspect of the present invention there is provided a thermosetting ink formulation obtainable by any one of the methods of the present invention.

The thermosetting ink of the invention may be used in numerous applications related to ink-jet applications, for example onto printed circuit boards as marking ink, solder resist, encapsulation of passive and active devices, embedded passives in PCB manufacturing, marking of semiconductor packages, sealing and bonding, underfill encapsulants, via holes plugging, conductors, heat conducting layers and forms in electronic manufacturing.

In yet another aspect of the present invention, there is provided a method for ink jet printing, said method comprising:

(i) providing the formulation of the present invention;

(ii) ink-jetting said formulation onto a substrate; and

(iii) curing said ink-jetted formulation under conditions suitable for obtaining a chemically and physically resistant cured print.

When the pigment or dye used in the method is a white pigment such as titanium dioxide, the color of the cured print is preferably white-to-light yellow (e.g. white, ivory, off-white, light yellow). When the formulation comprises a pigment other than white, the cured print which may be obtained by this method will take on different colors.

The thermal curing step is achieved by any curing method known to a person skilled in the art. Such methods may be selected from IR irradiation, convection oven heating, and any combination thereof.

In one embodiment of this aspect of the invention, curing is performed at temperatures lower than 200° C.; preferably lower than 180° C. and most preferably lower than 160° C.

The substrate on which said ink-jet printing is performed may be any such substrate on which ink-jet printing is possible. Such substrates may be selected from glass, glass fiber reinforced thermosetting laminate, organic fiber reinforced thermosetting laminate, PCB laminate, flexible PCB laminate, polyimide film and PCB thereof, ceramics, plastic, metal planes, metallic films (e.g. copper, gold, nickel, tin, silver), metallic lines and conductors, cured and semi cured photopolymers, metal oxides and cured and semi cured solder mask. A preferred substrate is the outer layer of a PCB.

In a preferred embodiment, the substrate is a PCB board including any surface feature on its outer layers, selected in non limiting manner from solder mask, lines, spaces, pads, vias and microvias. The resulting cured print, regardless of the substrate used, may be characterized as: (a) being immiscible in solvents; (b) white to light yellow in color; (c) hard and tough (d) high adherence to a substrate (d) resistant to molten solder and fluxes at temperatures up to 288° C. and (e) resistant against attack by surface finishing media such as ENIG and immersion tin.

### DETAILED DESCRIPTION OF THE INVENTION

While the present invention specifically discloses a formulation and a method suitable for applications by ink-jet printers, it should be understood by a person skilled in the art that the formulations and methods disclosed herein may also be utilized other printing methods and for other applications.

Additionally, it should be understood that the specific reagents disclosed herein are provided as mere examples and may be replaced by others suitable for the specific applications.

An important use of ink-jet formulations is as marking inks (legends) which are typically used to accurately mark the placement of components on bare boards or on solder mask coated board. The legend ink also finds great use in the drawing of serial numbers, barcodes or trademarks. As such, the marking ink must meet all of the criteria relating to the processing of PCBs, such as chemical resistance against process media, assembly processes and long-term durability of the assembled board.

Another important use of ink-jet formulations is in the selective masking of features on the PCB outer layers (solder mask or solder resist). Unlike graphic art inks that are subjected to mild environments, the legend ink or masking ink is exposed to harsh environments such as soldering (wave and reflow in the presence of aggressive flux, comprising acids, organic solvents and organic rosins at temperatures up to 288° C.), surface-finish baths of copper pads and lines such as immersion tin, electroless nickel gold plating (ENIG) (characterized by a combination of temperatures as high as 95° C., pH as low as 2, and aggressive reducing agents) and organic soldering preservatives (OSP). The combination of extreme pH, low molecular weight compounds and high temperatures, that is typical to these finishes, is extremely aggressive and easily attacks most of the common binders that are used in the inks and coatings. Typical polymers that are used in the ink jet industry and do not meet the criteria of the PCB industry are UV curable acrylates. Only high performance binders such as epoxy can meet the tough requirements of that environment; however these too are not optimal for reasons disclosed next.

Ink jet and especially industrial ink jet printers require ink that is also very latent, namely, having a viscosity change by no more than 2-10 Cps during storage and operation, for a period of usually at least 2 months and more typically 3-6 months. Most of the high performance thermoset resins, such as epoxy, are not latent enough. An examples of high performance, but not latent, epoxy legend ink used in the PCB industry is diglycidyl ether of bisphenol A epoxy resin (DGEBA) cured by dicyandiamide (DICY) and/or Imidazole. This ink is applied usually by screen printing. If an ink formulation that is not latent is loaded into an ink jet printer, the viscosity will increase to a level at which the nozzles of the ink jet printer head will become clogged and the printer will be irreversibly damaged. Ink formulations, however, which comprise highly latent thermosetting resins such as amino resins are not chemically resistant enough. Even when high cross linking density is achieved via a polyol, for example, the hydrolytic stability is not high enough to allow the formulation to survive the soldering and surface finishing media that are applied.

UV curable inks which are based on unsaturated monomers and oligomers such as acrylates and methacrylates are more chemically stable than amino resins based inks, but have poorer adhesion to substrates and a high degree of shrinkage. Some high performance unsaturated oligomers, such as acrylated epoxy resins or acrylated Novolac epoxy bring some improvement in chemical resistance, but their viscosity is extremely high, usually above 20,000 Cps at ambient, and yet their adhesion is insufficient.

Phenolic resins are very chemically and thermally resistant. They are also latent, but when cured tend to introduce dark color to formulations. Phenolic resins are usually the result of condensation between phenol, cresol or bis-phenol and formaldehyde and may also result from the addition or polymerization (cationic or anionic) of vinyl phenol with itself or with other unsaturated monomers.

Many phenolic resins are used in the PCB industry as curing agents of epoxy polyols (usually Diglycidyl Ether of Bisphenol A (DGEBA)). Phenolic resins are also used as curing agents in high performance molding and encapsulation of semiconductor devices. Due to the dark color of cured phenolic matrices those resins are limited to applications needing black or other dark colors.

In order to avoid the limitations of the existing ink-jet formulations, some of which were discussed herein the inventors of the present invention has sought the manufacture of ink-jet formulations which would exhibit low viscosity, high degree of chemical and physical resistance in the cured state, low color in the cured state, specific surface tension and high and constant latency.

The ink formulation of the present invention comprises at least one amino resin, at least one phenolic resin, at least one hydroxyl containing compound (referred herein as a polyol), and optionally other agents such as wetting and dispersing agents, pigments, dyes and fillers, solvents, adhesion promoters, curing catalysts, curing inhibitors, and either blocked acidic low molecular weight compounds or polymeric weak acid compounds.

The formulation was characterized as having a viscosity lower than 50 Cps at a shear rate of 10 to 100,000 sec⁻¹ measured at a temperature lower than 100° C. and a surface tension lower than 40 dynes/cm at the same temperature.

The formulation was also characterized by the color of the print after complete curing, namely by the color of the print which resulted from e.g. the ink-jet printing thereof on a certain substrate and the curing of said print. The color after complete curing of the un-pigmented print ranged from clear to light yellow at various curing temperatures ranging from 120 to 220° C. However, the color after complete curing (at the same temperature range) of a white-pigmented ink formulation ranges from white to light yellow-white.

As used herein, the term “latent” or any lingual variation thereof refers to a viscosity change of the said ink formulation of at most 10 Cps (centipoises), measured at the jetting temperature belonv 100° C., at a shear rate of at least 1,000 sec⁻¹, after the formulation having been stored for at least 3 months at a temperature of about 22-25° C. “Highly latent” refers to a viscosity change of said ink formulation of at most 4 Cps under the same conditions mentioned hereinbefore. The unit “Cps” (Centipoise) as used herein refers to the viscosity-measuring unit, defined as a centimeter-gram-second unit of dynamic viscosity equal to one hundredth (10⁻²) of poise.

The term “viscosity” refers to the ratio between shear stress and shear rate. The viscosity of polymeric inks is usually non-Newtonian, namely the viscosity changes as shear rate changes. In most inks, the viscosity decreases as shear rate increases (the so-called Shear-Thinning effect).

The term “shear rate” refers to the ratio between velocity of a liquid and the distance between the two shearing planes (for example tube wall, nozzle diameter):

$$\frac{Velocity}{Clearance} = \frac{cm \text{/} sec}{cm} = {sec}^{- 1}$$

The term “surface tension” refers to a property of liquids arising from unbalanced molecular cohesive forces at or near the surface, as a result of which the surface tends to contract and has properties resembling those of a stretched elastic membrane. Surface tension, measured in Newtons per meter (N·m⁻¹), or Dynes per cm, s is represented by the symbol σ or γ or T and is defined as the force along a line of unit length perpendicular to the surface, or work done per unit area.

The term “resin” refers to a monomer, oligomer, polymer or any combination of said compounds characterized by an average of more than one reactive group per molecule, said reactive group being able to react with a second reactive compound (so called “cross linker”) to form a cross-linked thermosetting network.

The term “cross linker” or any lingual variation thereof refers within the context of the present invention to a monomer, oligomer, polymer or any combination of said compounds, characterized by an average of more than two reactive groups per molecule (i.e. monomer, oligomer, polymer), being able to react with a second compound to form a cross-linked thermosetting network. The expression “capable of cross linking” or any lingual variation thereof, refers to the ability of one compound to form a cross-linked thermosetting network under the curing conditions of the procedure.

“Amino resins” are amine-based reactive compounds which may be selected from melamine monomer or polymer, melamine-formaldehyde resins, benzoguanamine-formaldehyde resins, urea-formaldehyde resins, glycoluril-formaldehyde resins, triazine based amino resins and combinations thereof. Typical amino resins include the melamine resins manufactured by CYTEC such as Cymel 300, 301, 303, 325 350, 370, 380, 1116 and 1130; benzoguananiine resins such as Cymel R 1123 and 1125; glycoluril resins such as Cymel 1170, 1171, and 1172 and urea resins such as CYMEL U-14-160-BX, CYMEL UI-20-E.

Amino resins—preferably the polymeric and oligomeric type, react readily with the polyol and phenolic resin at temperature greater than 100° C., and more preferred at temperatures greater than 120° C., without losing latency during storage at ambient. Introduction of such polymeric or oligomeric resins improves adhesion to metallic surfaces as well as cross-linking efficiency. Examples for polymeric and oligomeric type amino resins are CYMEL 325, CYMEL 322, CYMEL 3749, CYMEL 3050, CYMEL 1301 melamine based resins, CYMEL U-14-160-BX, CYMEL UI-20-E urea based amino resins, CYMEL 5010 and benzoguanamine based amino resin and CYMEL 5011 based amino resins, manufactured by CYTEC.

Monomeric type amino resins are for example CYMEL 300, CYMEL 303, CYMEL 1135 melamine based resins, CYMEL 1123 benzoguanamine based amino, CYMEL 1170 and CYMEL 1171 Glycoluril amino resins and Cylink 2000 triazine based amino resin, manufactured by CYTEC.

When monomeric type amino resins are used, blocked acidic catalyst is required at amount of about 0.1-8% of the total weight of the formulation, preferably in the range of 0.5-5%. Examples of such catalysts are amine or organic blocked aromatic acids, such as NACURE 1323, NACURE 5414, and NACURE 1953, manufactured by King Industries.

The amino resins are reactive towards hydroxyl, carboxyl or amide containing molecules, most often with the hydroxyl containing compounds due to the hydroxyl's reactivity and wide spectrum of raw materials.

The term “polyol” refers to any compound, selected in non limiting manner from aliphatic, aromatic, heterocyclic, alicyclic compounds, silicon containing compounds, having at least one hydroxyl (OH) group bonded thereto. The hydroxyl group is one capable of reacting with said amino resin and phenolic resin, as will be discussed hereinnext.

The polyol component in the formulation should provide compatibility between the amino resin and the phenolic resin. At the same time, the polyol should also have good chemical and thermal resistance. Aromatic polyols are preferred. Ester groups in the main chain of said polyol are typically not recommended.

One group of polyols that meets the requirement disclosed hereinbefore is the diglycidyl ether of bisphenol A (DGEBA), or other diglycidyl ether of bisphenols such as Bisphenol F and Bisphenol S, each characterized by having aliphatic hydroxyls groups as side groups and two terminal epoxy groups, which undergo reaction with the phenolic resin, as end groups.

Examples for DGEBA polyols are EPON 1001F, EPON 2002, EPON 2042, EPON 2012, manufactured by Resolution, Araldite GT 1804, Araldite GT 7071, Araldite Tactix 123 and 128, manufactured by Vantico.

The diglycidyl ether of bisphenols A, S and F has the following general formula:

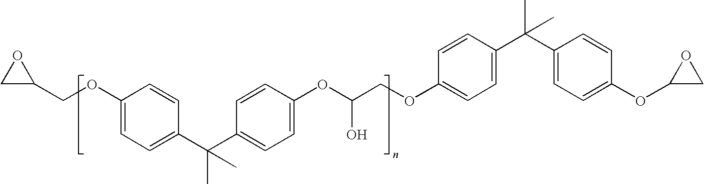

Another family of polyols which are similar to the DGEBA polyols in structure and performance is the family of phenoxy resins manufactured by InChem. Also may be used are high performance and low viscosity polyols such as 4-t-butylcatecol type liquid epoxy, commercially available under the trade name EPICLON HP-840 by Dainippon ink and chemicals, inc, having the following general structure:

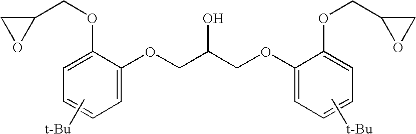

Another family of high performance polyols, providing good balance of chemical and physical properties is styrene-allyl alcohols (SAA) copolymers manufactured by Lyondell, and having the following general structure:

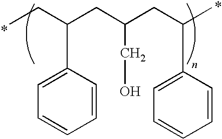

Cycloaliphatic polyols, and most preferably cyclohexane dimethanol, shown below, are also polyols exhibiting high performance.

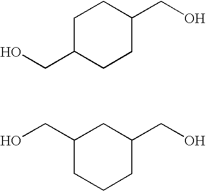

In a preferred embodiment, a mixture of isomers of said polyol, commercially available under the name UNOXOL by DOW, is utilized as one of the polyols in the formulation of the present invention.

“Phenolic resins” are phenol-based resins which are selected from phenol aldehyde condensates (known as Novolak resins) including hydrogenated grades of said resins, homopolymers and copolymers of alkenyl phenols including hydrogenated grades of said resins, poly(vinyl phenol) resins including co-polymers thereof with other unsaturated monomers such as styrene, acrylic or methacrylic acid and esters thereof, and including hydrogenated grades of said resins, polymers comprising phenolic units and non-aromatic cyclic alcohol units including hydrogenated grades of said resins, and homo-polymers and co-polymers of N-hydroxyphenyl-maleimides. The phenolic resin may be etherified for improved latency, flexibility and for providing a light color to the resin and to the cured polymers thereof.

Surprisingly, when phenolic resins are incorporated into the amino resin/polyol mixture, even in small amounts, e.g. between about 1-15% of total ink weight, the chemical and thermal resistance of the ink formulation improves dramatically. The most effective content is 1-8% of total ink weight, where chemical and thermal resistance is excellent, and the color is neutral with almost no dark discoloration. Such a coloring allows pigmentation of the ink to almost any color and/or shade, including white. In order to minimize coloration of cured film, selected grades of phenolic resins are most preferred. These are for example etherified phenolic resins, for example the grade FB210B60 manufactured by Schenectady, hydrogenated phenolic resins, vinyl phenols and copolymers thereof and hydrogenated vinyl phenol resins, for example MARUKA LYNCUR resins, manufactured by MARUZEN Japan.

Examples of etherified phenolic resin building blocks are:

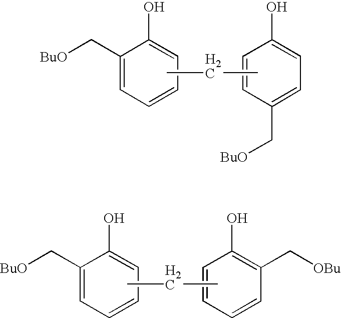

Examples of the vinyl phenol resin and its copolymer building blocks are:

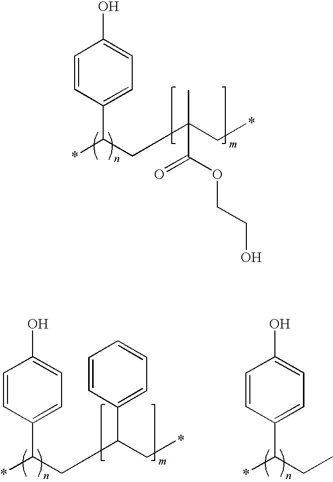

Very durable compositions are obtained when phenolic resin and amino resin are at about the same weight percentage.

When only a phenolic resin (even very light color etherified resin) and a polyol are used as binders, a dark honey-brown film or print is obtained after curing at temperatures as low as 120° C. When an amino resin and a phenolic resin are used as binders without an hydroxyl containing compound (diol, triol or polyol), incompatibility is observed, wherein the phenolic resin is floating over the amino resin, and when cured, a brown glaze is obtained.

For marking (Legend) ink of PCB, the white colored print is most preferred by the PCB industry. In order to obtain a white to light-yellow color print, at least one white pigment is added to the formulation. In a preferred embodiment, the formulation comprises a white pigment such as Kronos titanium dioxide manufactured by kronos, about 1-8% of at least one phenolic resin, 2-15% of at least one amino resin and about 1-15% of at least polyol. In a particularly preferred case, the formulation comprises between 10 and 45% of said pigment.

The percent expressions used herein refer to percent weight of a specific component of the total weight of the ink. For example, the expression “1-50%” of a certain component refers to any ratio from a 1% of the total weight of the formulation up to 50% of the weight of the same formulation. The expression “between about 1-50%” refers to a percent weight which may be slightly below or slightly above the whole percentage value. For example, “about 1%” refers also to 0.6, 0.7, 0.8, 0.9, 1.1, 1.2, 1.3 etc percent. It should be recognized that such variations on the whole numerical values as mere equivalents and thus as values which fall within the scope of the claimed invention.

In another preferred embodiment, the formulation comprises a green pigment such as phthalocyanine green, for example IRGALITE Green GFNP manufactured by Ciba or Hostaperm Green GG 01 manufactured by Clariant, about 1-25% of at least one phenolic resin, 1-15% of at least one amino resin and about 1-15% of at least one polyol. In a particularly preferred case, the formulation comprises between 10 and 45% of said pigment.

In another preferred embodiment, the formulation comprises about 1-25% of at least one phenolic resin, 1-15% of at least one amino resin, about 1-15% of at least one polyol, 10-45% of barium sulfate and phthalocyanine green pigment in an amount of between 1-5% of the total weight of the invention. This formulation is used on PCBs as solder mask or solder resist.

The ink may further comprise oligomer or polymer, having an acid number greater than 50 mg KOH/gr, more preferably greater than 100 mg KOH/gr and most preferably greater than 120 mg KOH/gr. The acidic groups bonded to said at least one oligomer or polymer are preferably selected from carboxyl, organic anhydrides, phosphoric ester derivatives and combination thereof. One group of preferred oligomers are the weakly acidic oligomers or polymers which are on one hand capable of catalyzing cross-linking at elevated temperatures, e.g. above 120° C., and on the other have adhesion promoting properties.

The weakly acidic oligomers or polymers are preferably selected in a non limiting manner from (a) acrylic or methacrylic acid co-polymers with other unsaturated monomers such as styrene, (b) maleic acid or anhydride copolymer with other unsaturated monomers such as styrene (For example Styrene-Maleic anhydride copolymer) graft polymers wherein grafted group selected from carboxylic acids or anhydrides thereof, polymers comprising phosphoric group and esters thereof, such as the additive ADDITOL XL 180 manufactured by Solutia, and unsaturated polycarboxylic resins characterized by dual functionality, such as Sarbox SB500E 50 manufactured by Sartomer.

Another family of acidic oligomers is Styrene-Maleic anhydride resins, for example SMA 3000 resin by Sartomer.

Other examples of such acidic polymers are styrene-acrylic acid copolymer, and acrylic acid containing copolymers with ethylene or other acrylates or allyl alcohol. Other example for such acidic polymers, are the reaction of polyhydric alcohols with polycarboxylic acids or anhydrides—where the acid is in excess.

The acidic polymeric compound is mostly effective at levels of 1-10% of formula weight, and more preferred at level of 0.5-5% of formula weight. Unlike strong acid catalysts that remain as a “dopant” in the cured film and may cause future problems, the acidic polymer is a “catalyst” for the curing stage and becomes part of the cured network, either via a reaction of amino resin and a carboxyl or via the additional OH groups in its chain. Another advantage of this “catalyst” is the improved adhesion of cured film to metals, glass and ceramic material as well as the potential “developability” of cured film in alkaline medium (Important feature for rework purposes, when cured ink needs to be removed without harm to the PCB).

In order to avoid a certain degree of curing which exists at the ambient (and thus ensure latency) and in order to initiate enough cross linking at 150° C., volatile amine inhibitor such as N-methyl-diethanolamine (MDEA) is provided to the ink formulation. Inhibitors such as MDEA are introduced into the formula at levels of 0.01 to 1.5% of the formula, more preferred at 0.1 to 0.7% of the formula.

The amine neutralizes free acidic species when the ink is stored or even in the ink jet reservoir and pipes. Only when temperature is above about 100° C. and evaporation of the amine inhibitor is enabled, the blocking is removed and the curing reaction is enabled.

Another embodiment relates to a case where some or all of the hydroxyl containing compounds are replaced by hydroxyl containing compounds that have additional unsaturated groups (molecule comprising at least one vinyl, acryl, methacryl or allyl or reactive double bond, and at least one primary or secondary hydroxyl group) that can be activated in response to UV or visible light in the presence of photoinitiator and optionally sensitizer.

Thus, the ink may further comprise at least one unsaturated reactive monomers, oligomers and/or polymers, selected from acrylic acid and methacrylic acid derivatives, allyl ethers and esters, vinyl ethers and esters and unsaturated polyesters, and combinations thereof. Usually the at least one unsaturated reactive compounds is present in an amount between 2-40% of the weight of the formulation, more preferably between 2 to 20% and most preferably in an amount between 2 to 15% of the total weight of the formulation.

Examples of unsaturated hydroxyl compound are hydroxy alkyl acrylates and methacrylates such as hydroxy ethyl acrylate or methacrylate, acrylate or methacrylate esters of polyhydric alcohols, for example SR 444 by Sartomer, where one or more hydroxyls per molecule remains unreacted, allyl alcohol for example allyl alcohol propoxylate, sold as AP 1.6 by Lyondell, allyl ethers and esters of polyhydric alcohols, for example allyl pentaerythritol (triallyl pentaerythritol) sold as APE by Perstrop, or allyl ethers of trimethylol propane, pentaerythritol and glycerol, sold under the names Neoallyl T-20, P-30 and E-10, respectively, by DAISO Co. LTD, Japan and heterocyclic polyols and the reaction products of maleic anhydride and polyhydric alcohols.

The combination of a phenolic resin, amino resin, and polyol and optionally of polymeric acidic compound with a UV or visible light curable ingredient also increases the printing quality. The printing quality is typically controlled by the time gap between the ink-drop landing on the substrate and the UV or visible light interaction with the ink. Since the drop of the ink begins propagating on said substrate immediately after landing, and since most solvents in conventional ink jet formulations are low volatility, solvent-based ink fail to provide high resolution printing of, for example small features and fine lines. The photo-sensitive ingredients in the formulations of the invention provide reactivity under exposure to light. A light source, being generally actinic radiation, e.g. visible or UV is applied in synchronization with printing. The exposure to light activates the photoinitiator, and the unsaturated compounds cross-link. The viscosity of the ink increases significantly and the propagation of the ink on the substrate is arrested. The print quality is thus controlled by the time between drop landing and the light exposure. The hydroxyl groups in the unsaturated cross-linked net react in the second stage with the amino and phenolic resins, so as to allow the two networks to interpenetrated and coupled.

The introduction of hydroxyl containing unsaturated reactive compounds enables compatibility between said ink and other non hydroxyl-containing unsaturated compounds. The latter are selected in a non limiting manner from acrylic acid and methacrylic acid derivatives such as isobornyl acrylate, such as SR 506 by Sartomer, acrylate esters of short polyols and polyhydric alcohols such as SR 238, SR 295, SR 454, SR 494, SR 355, SR 306, SR 399, by Sartomer, urethane acrylate, such as CN9006, CN9008 by Sartomer, acrylate ester of tris-2-hydroxyethyl Isocyanurate such as SR 368 by Sartomer, acrylate esters of cycloaliphatic diols and polyols, such as SR833S (also referred to as tricyclodecane dimethanol diacrylate), PRO6622, NTX7393, PRO7149, by Sartomer, high functionality polyacrylate, such as CN2303 by Sartomer, allyl ether, allyl esters, especially diallyl phthalate and triallyl isocyanurate, such as SR 533 by Sartomer, and triallyl cyanurate, such as SR 507 by Sartomer.

In order to cure or more preferably to enable significant increase in viscosity of the formulation of the invention, the printed ink is exposed to UV or visible light provided by suitable sources of actinic radiation include halogen light, mercury lamps, xenon lamps, carbon arc lamps, tungsten filament lamps, lasers, electron beam and sunlight. Ultraviolet (UV) radiation is preferably emitted by medium pressure mercury lamps. Thus, the initiator is preferably a photo-initiator, capable of generating active free radicals and/or anions and/or cations, which are themselves able to initiate polymerization of the said unsaturated reactive monomers and other ingredient of said ink.

Preferably, the photo-initiators are selected from anthraquinone and derivative thereof, acetophenones, 1-hydroxy cyclohexyl-phenylketone and 2-methyl-1-(4 methylthio)phenyl-2-morpholin-propan-1-one, thioxanthones, ketals such as acetophenone dimethylketal and dibenzylketal, benzoins and benzoin alkyl ethers such as benzoin, benzyl benzoin methyl ether, benzoin isopropyl ether and benzoin isobutyl ether; azo compounds such as azobisisovaleronitrile, benzophenones such as benzophenone, methylbenzophenone, 4,4-dichlorobenzophenone, 4,4-bis-diethylamino benzophenone, Michler's ketone and xanthones, including mixtures thereof.

Important commercial initiators are Speedcure (trade mark) ITX, EHA and 3040, Irgacure™ 184, 369, 907 and 1850 and Darocure™ 1173.

Cationic photoinitiators may be introduced as well in order to promote reaction of the hydroxyl groups and the phenolic and amino reactive groups. The cationic photoinitiators are selected from triarylsulphonium (TAS) and diaryliodonium (DAI) salts.

An optimized level of unsaturated monomers enables to manipulate drop propagation on the PCB after jetting, so as printing quality (resolution) is improved. It should be noted that at low concentrations of said unsaturated hydroxyl compounds and unsaturated monomers in the ink, for example less than 2%, no significant response to UV or visible light is observed. At too higher concentrations, for example above 45%, the cross linking density in response to UV or visible light, is too high, thus shrinkage deteriorates adhesion and solvents can not be released from the film without cracking it.

When ink is applied onto the substrate, even the smallest of drops propagates on substrate due to wetting. The result is a thinner film with limited hiding power and broadened drop size which results in an inferior resolution. If UV or visible light is applied immediately after drop landing, and the unsaturated hydroxyl compound as well as the other unsaturated monomers are polymerized by free radical mechanism initiated by the photoinitiator, then the drop “freezes” and the diameter and thickness is controlled.

### EXAMPLE 1

### Method for the Preparation of the Ink Formulation

Each ink formulation disclosed herein was prepared according to the following procedure:

1. mixing all organic ingredients i.e., amino resin, phenolic resin, polyols, solvents, monomers, polymers, oligomers, non reactive compounds, defoamers, wetting agents, dispersing agents, and adhesion promoters until a clear solution is obtained;

2. adding the pigment or dye and dispersing of the mixture of step (1) by means of high shear mixer until a smooth slurry is obtained;

3. milling said dispersion of step (2) by a horizontal or beadmill loaded by 0.2-1 mm Zirconia or Alumina or glass milling media, at shaft speed of 1000 to 4000 RPM, for 0.5-10 minutes of residence time until at least 90% of the said liquid is able to pass through a 2− or less micron filter;

4. optionally adding heat sensitive components to the filtered liquid and mixing by means of a low shear mixer; and

5. filtering the liquid ink of step (4) through a 2− or less micron filter, thereby obtaining the ink formulation of the present invention.

### EXAMPLE 2

### Physical Measurements

Surface tension was evaluated by the Du Nouy ring method (KRUSS Company).

Viscosity vs. shear rate was measured by the cone and plate Rheometer Model HHAKE RheoStress 1 (Haake company)

Inks were printed by digital ink jet (such as Printar model LGP 809 manufactured by Printar LTD) onto PCB boards (such as substrate FR4, coated by 10-50 microns solder mask Taiyo PSR4000 that is fully cured). The inks were air dried for 5 minutes and cured for 90 minutes at 150° C. The color was examined under white fluorescent light and chemical resistance was evaluated as detailed in Table 1.

Latency was measured as an increase of viscosity as a result of exposure of the ink to storage at 50° C. for a week, simulating 2-month storage at ambient or by storing at 20 to 25° C. for 3 months.

### EXAMPLE 3

### A First Exemplary Formulation

### A. The Formulation Comprising:

1. an amino resin such as Cymel 325 by Cytec at a quantity of about 3-15% of the total formulation;

2. etherified light color phenolic resin such as Schenectady FB210 B60 by Schenectady at a quantity of about 1-15% of the total formulation;

3. DGEBA polyol such as EPON 1001F by Resolution at a quantity of about 1-15% of the total formulation;

4. an acidic polymer as adhesion promoter/catalyst such as SB500E50 by Sartomer at a quantity of about 2-10% of the total formulation;

5. a pigment such as Kronos 2310 Titanium Dioxide at a quantity of about 20-55% of the total formulation;

6. an organic solvent such as Dowanol PMA manufactured by DOW and/or Propylene Carbonate and/or combination thereof, at quantities ranging from 20 to 60% of the total formulation;

7. a wetting agent such as BYK 353 so as to achieve a final surface tension of 27 to 35 dynes/cm

8. a dispersing agent such as BYK 111 and/or DisperByk 161 to stabilize said pigment particles from sedimentation and hard cake formation; and

9. MDEA inhibitor at an amount of about 0.2-0.8% of the ink weight in order to extend pot life and shelf life.

### B. Physical Characteristics:

The resulting ink formulation exhibited excellent properties which make it suitable for use as a marking ink in the PCB industry.

The formulation was measured to have a viscosity of about 11-12 Cps at 45° C., when measured at a shear rate of 3000 sec⁻¹ and 8-10 Cps at 45° C., when measured at a shear rate of 5000 sec⁻¹; surface tension of 27 to 33 dynes/cm; excellent latency when stored at 20 to 25° C. for 3 months; and showed an increase of less than 2 Cps in its viscosity as measured at 45° C. at a shear rate of 5000 sec⁻¹ after storage of 3 months at 20 to 25° C.

Additionally, the pigment dispersion was very good. No hard cake was formed during storage. After storage at ambient for 3 months, only a slight agitation was required in order to re-disperse the pigment. The properties of the stored formulation were the same as those of the original formulation, with the exception of the slight increase in viscosity discussed above.

### C. Application and Curing of the Ink:

The ink formulation was applied by ink Jet printer (LGP 809 manufactured by Printar LTD, Israel) onto a solder mask (type Taiyo PSR-4000) coated printed circuit board and cured. The ink cured at temperatures in the range of 150 to 180° C. showed film and character resistance.

The chemical resistance of the print was very good and passed all criteria listed in IPC TM-650/2.4.1.1B and 2.3.4.B, and IPC SM-840C that relates to solder mask applications (The IPC standards are international specifications established by the Institute of Interconnecting and Packaging Electronic Circuits). Additionally, the formulation exhibited excellent resistance to soldering conditions (Pb-Sn solder+organic flux, 230-288° C., 5-30 seconds exposure, 5 repeating exposures followed by tape adhesion test) or chemical finishes such as immersion tin, Electroless Ni/Au, OSP (Organic soldering preservative), immersion silver and electroplating (Ni and Au). Prints cured 30 minutes at 180° C. had similar chemical and physical properties as prints cured 60 minutes at 160° C. and prints cured 90 minutes at 150° C. At 150° C. curing provided nearly white prints, whilst at 160° C. and 180° C. curing temperatures, slight yellower color print was observed.

### EXAMPLE 2

### A Second Exemplary Formulation

### A. The Formulation Comprising:

1. an amino resin such as Cymel 303 by Cytec at a quantity of about 3-15% of the total formulation;

2. an etherified light color phenolic resin such as Schenectady FB210 B60 by Schenectady at a quantity of about 1-15% of the total formulation;

3. DGEBA polyol such as EPON 1001F by Resolution at a quantity of about 1-15% of the total formulation;

4. an acidic polymer as adhesion promoter/catalyst such as SB500E50 by Sartomer at a quantity of about 2-10% of the total formulation;

5. a blocked strong acid to promote the monomeric amino resin, for example Nacure 1323 By King industries at level of 0.5-5% of ink weight;

6. a pigment such as Kronos 2310 titanium dioxide at a quantity of about 20-55% of the total formulation;

7. an organic solvent such as Dowanol PMA manufactured by DOW and/or propylene carbonate and/or a combination thereof, at quantities ranging from 20 to 60% of the total formulation;

8. a wetting agent such as BYK 353 to provide the formulation with a final surface tension in the range of 27 to 35 dynes/cm;

9. a dispersing agent such as BYK 111 and/or DisperByk 161 to stabilize pigments from sedimentation and hard cake formation; and

10. MDEA inhibitor at a loading of about 0.2-0.8% of the ink weight to extend the pot life and shelf life of the formulation.

### B. Physical Characteristics:

The resulting ink exhibited excellent properties making it suitable as an ink-jet marking ink for the PCB industry.

The formulation exhibited a viscosity of about 11-12 Cps at 45° C., when measured at a shear rate of 3000 sec⁻¹ and 8-10 Cps at 45° C., when measured at a shear rate of 5000 sec⁻¹; a surface tension of 27 to 33 dynes/cm; an excellent latency when stored at 20 to 25° C. for 3 months, and showed an increase of less than 2 Cps in its viscosity as measured at 45° C. at a shear rate of 5000 sec⁻¹ after storage of 3 months at 20 to 25° C.

Additionally, the pigment dispersion was very good. No hard cake was formed during storage. After storage at ambient for 3 months, only a slight agitation was required in order to re-disperse the pigment. The properties of the stored formulation were the same as original, with the exception of only a slight increase of viscosity by less than 2 Cps.

### C. Application and Curing of the Ink:

The ink was applied by ink Jet printer (LGP 809 manufactured by Printar LTD, Israel) onto a solder mask (type Taiyo PSR-4000) coated printed circuit board and cured. The ink cured at temperatures in the range of 150 to 180° C., to an extremely resistant film or characters.

The chemical resistance was very good and passed all criteria listed in IPC TM-650/2.4.1.1B and 2.3.4.B, and IPC SM-840C that relates to solder mask applications (The IPC standards are international specifications established by the Institute of Interconnecting and Packaging Electronic Circuits). Additionally, the cured print exhibited excellent resistance to soldering conditions (Pb-Sn solder+organic flux, 230-288° C., 5-30 seconds exposure, 5 repeating exposures followed by tape adhesion test) or chemical finishes such as immersion tin, Electroless Ni/Au, OSP (Organic soldering preservative), immersion silver and electroplating (Ni and Au). Prints cured 30 minutes at 180° C. had similar chemical and physical properties as prints cured 60 minutes at 160° C. and as prints cured 90 minutes at 150° C. The prints which were cured at 150° C. were almost white in color, whilst at elevated curing temperatures, a slight yellower color was observed.

### EXAMPLE 4

### A Third Exemplary Formulation

### A. The Formulation Comprising:

1. an amino resin such as Cymel 325 by Cytec at a quantity of about 3-15% of the total formulation;

2. an etherified light color phenolic resin such as Schenectady FB210 B60 by Schenectady at a quantity of about 1-15% of the total formulation;

3. DGEBA polyol such as EPON 1001F by Resolution at a quantity of about 1-15% of the total formulation;

4. an acidic polymer as adhesion promoter/catalyst, such as SB500E50 by Sartomer, at a quantity of about 2-10% of the total formulation;

5. an hydroxyl containing unsaturated monomer, such as SR 444 by Sartomer, at a quantity of about 2-5% of the total formulation;

6. SR 368 tri-acrylate by Sartomer, or diallyl phthalate or triallyl Isocyanurate, at a quantity of about 2-10% of the total formulation;

7. a photoinitiator such as CIBA Darocur TPO, at a quantity of about 2-7% of the total formulation;

8. a sensitizer such as Esacure ITX by Esacure at a quantity of about 0.5-5% of the total formulation;

9. a pigment such as Kronos 2310 titanium dioxide at a quantity of about 20-55% of the total formulation;

10. optionally, a barium sulfate filler such as Sachtleben Blank Fixe micro by Sachtleben, at a quantity of up to 55% of the total formulation;

11. an organic solvent such as Dowanol PMA by DOW and/or propylene carbonate and/or combination thereof, at a quantity ranging from 20 to 60% of the total formulation;

12. a wetting agents such as BYK 353 so as to afford a final surface tension in the range of 27 to 35 dynes/cm;

13. a dispersing agents such as BYK 111 and/or DisperByk 161 to stabilize pigments from sedimentation and hard cake formation; and

14. MDEA inhibitor at loading of about 0.2-0.8% of the total weight of the formulation.

### B. Physical Characteristics:

The resulting ink exhibited excellent properties making it suitable for use as ink-jet marking ink for the PCB industry.

The formulation was determined to have the following characteristics: a viscosity of about 11-12 Cps at 45° C., when measured at a shear rate of 3000 sec⁻¹ and 8-10 Cps at 45° C., when measured at a shear rate of 5000 sec⁻¹; a surface tension of 27 to 33 dynes/cm; and an excellent latency when stored at 20 to 25° C. for 3 months. Additionally, the formulation showed increase of less than 2 Cps in its viscosity as measured at 45° C. at a shear rate of 5000 sec⁻¹ after storage of 3 months at 20 to 25° C. The pigment dispersion was very good, and no hard cake was formed during storage. The ink properties were measured after storage at ambient for 3 months, wherein only slight agitation was needed in order to re-disperse the pigment.

### C. Application and Curing of the Ink:

The ink was applied by ink Jet printer (LGP 809 manufactured by Printar LTD, Israel) equipped by medium pressure mercury lamp that is synchronized with jet timing, so as the time between drop landing on the substrate and UV and visible light exposure, was controlled. The ink was jetted onto a solder mask, (type Taiyo PSR-4000) coated printed circuit board. The ink was first “frozen” by UV and visible light irradiation to bring the viscosity increase to a “no-flow” state even upon exposure to elevated temperatures during thermal curing. The printed and “frozen” ink was then thermally cured at temperatures in the range of 150 to 180° C., to an extremely resistant film or characters. The chemical resistance was very good and passed all criteria listed in IPC TM-650/2.4.1.1B and 2.3.4.B, and IPC SM-840C that relates to solder mask applications (The IPC standards are international specifications established by the Institute of Interconnecting and Packaging Electronic Circuits).

The printed ink also showed excellent resistance to soldering conditions (Pb—Sn solder+organic flux, 230-288° C., 5-30 seconds exposure, 5 repeating exposures followed by tape adhesion test) or chemical finishes such as immersion tin, Electroless Ni/Au, OSP (Organic soldering preservative), immersion silver and electroplating (Ni and Au). Prints cured 30 minutes at 180° C. exhibited similar chemical and physical properties to prints cured 60 minutes at 160° C. and to prints cured 90 minutes at 150° C. The 150° C. curing provided nearly white prints, whilst at elevated curing temperatures, slight yellower color was exhibited.

### EXAMPLE 5

### A Fifth Exemplary Formulation

Table 2 shows the constituents of a white marking ink formulation in accordance with the present invention. The ink was shown to have high latency. When MDEA content was increased to 0.45%, the viscosity increased by less than 1 Cps, after three months of storage.

The ink was applied by ink jet as legend mark, in the form of thin and very fine characters on PCB coated by solder mask type Taiyo PSR-4000. The printed board was placed in a convection oven at 150° C. for 90 minutes for curing of the printed ink. The color of letters was white with slight white-to-yellow color.

The cured ink sustained attack by most aggressive fluxes, even at soldering with lead-free solders at temperatures as high as 288° C. The cured ink showed specific and very high resistance against attack by ENIG, immersion tin and immersion silver surface finishes.

### EXAMPLE 6

### A Sixth Exemplary Formulation

Table 3 shows the constituents of a white marking ink formulation in accordance with the present invention. The ink showed high latency. When MDEA content increased to 0.45%, the viscosity increased by less than 1 Cps, after storage for for 3 months.

The ink was applied by ink jet, as legend mark in the form of thin and very fine characters, on PCB coated by solder mask type Taiyo PSR-4000. The printed board was placed in a convection oven at 150° C. for 90 minutes for curing of the printed ink. The color of letters was white with no yellow discoloration. The cured ink had very high resistance against attack by most aggressive fluxes, even at soldering with lead-free solders at temperatures as high as 288° C. The cured ink had very high resistance against attack by ENIG, immersion tin and immersion silver surface finishes.

### EXAMPLE 7

### Additional Ink Formulations

Table 4 lists further ink formulations which have been similarly prepared using the method of the invention.

In Table 4:
Cymel 325 and Cymel 303 are amino resins manufactured by Cytec;
Epon 1001 is a solid low molecular weight DGEBA resin having OH equivalent weight of 350 and manufactured by Resolution Performance Products;
FB210B60 is a phenolic resin manufactured by SCHENECTADY EUROPE S.A.S;
SB500E50 is a high acid number unsaturated polymer solution in acrylic monomer manufactured by Sartomer;
the TiO2 pigment is Kronos 2310 manufactured by Kronos;
N3525 (Nacure 3525) is a blocked acid (DNNDSA type) manufactured by King Industries; and
DPM is a solvent (Dowanol DPM) manufactured by DOW.

The results of the chemical stability tests for the different compositions are listed in Table 5.

As may be noted, the formulations of the present invention may be varied as shown in Tables 4 and 5 in order to achieve variability and versatility of applications. Formulations A3-5 and A9-A11 showed good to excellent chemical resistance to the variety of conditions and afforded light color when cured.

The results also indicate that the formulations of the invention cannot be regarded as a direct or indirect departure from the current state of the art. The high degree of fine tuning which is required in order to achieve the combination of all chemical and physical characteristics needed, as disclosed hereinabove, is clear from these results.

### EXAMPLE 8

### Latency Measurements

The latency of the ink formulations was determined according to the following procedure: an ink sample was placed in a sealed glass container in an oven at 50° C. for 1 week to accelerate reactions that may be responsible to a viscosity increase. The ink was mixed by a shaker to disperse the sediment pigment and then remained at the ambient for 30 minutes in order to allow release of air bubbles. The viscosities at shear rate of 5000 sec⁻¹ (high shear) at 45° C. were measured by the cone and plate Rheometer Model HHAKE RheoStress 1. The viscosity of the original ink (1 day after preparation) was compared to the viscosity of the aged ink. The measurements are listed in Table 6.

TABLE 1
list of testing procedures for the chemical resistance of the ink formulations

| Procedure Description | Chemical medium | Exposure time and Temperature | Pass criteria |
|---|---|---|---|
| Resistance to organic solvent | Dichloromethane (DCM) | 50 rubbings, cotton cloth, ambient | No printed material was Attacked |
| | | | (visual) or lost |
| | | | Adhesion (tape test) |
| Resistance to soldering | Flux AF 1863, | 5 times 10 seconds @ 260 Celsius, | No printed material was Attacked |
| | manufactured by Enthone, | | (visual) or lost |
| | solder Pb37Sn63 | | Adhesion (tape test) |
| Resistance to immersion Tin | Immersion Tin by Atotech | According to manufacturer | No printed material was Attacked |
| surface finish | | recommendations | (visual) or lost |
| | | | Adhesion (tape test) |
| Resistance to electroless | ENIG by Atotech | According to manufacturer | No printed material was Attacked |
| Nickel/gold (ENIG) surface | | recommendations | (visual) or lost |
| finish | | | Adhesion (tape test) |

TABLE 2
An examplary white marking ink formulation

| material | weight | % of formula |
|---|---|---|
| EPON 1001 | 800 | 5.83 |
| FB210B60 | 800 | 5.83 |
| CYMEL 325 | 850 | 6.19 |
| SB500E50 | 350 | 2.55 |
| Dispersants | 400 | 2.91 |
| Solvent | 6300 | 45.90 |
| MDEA | 25 | 0.18 |
| NACURE 1323 | 0 | 0.00 |
| KRONOS 2310 | 4200 | 30.60 |
| SUM | 13725 | |

TABLE 3
An examplary white marking ink formulation

| material | weight | % of formula |
|---|---|---|
| EPON 1001 | 530 | 3.88 |
| FB210B60 | 250 | 1.83 |
| CYMEL 325 | 1600 | 11.72 |
| SB500E50 | 350 | 2.56 |
| Dispersants | 400 | 2.93 |
| Solvent | 6300 | 46.14 |
| MDEA | 25 | 0.18 |
| NACURE 1323 | 0 | 0.00 |
| KRONOS 2310 | 4200 | 30.76 |
| SUM | 13655 | |

TABLE 4
An exemplary set of ink formulations of the present invention.

| Formula | Cymel | Cymel | Epon | FB210B60 | SB500E50 | TiO₂ | N3525 | DPM |
|---|---|---|---|---|---|---|---|---|
| name | 325 (grams) | 303 (grams) | 1001 (grams) | (grams) | (grams) | (grams) | (grams) | (grams) |
| A1 | 18.000 | 0.000 | 35.000 | 0.000 | 10.600 | 87.520 | 0.000 | 100.646 |
| A2 | 18.000 | 0.000 | 9.000 | 0.000 | 5.400 | 41.760 | 0.000 | 49.391 |
| A3 | 9.000 | 0.000 | 9.000 | 9.000 | 5.400 | 38.880 | 0.000 | 47.472 |
| A4 | 6.000 | 0.000 | 9.000 | 12.000 | 5.400 | 37.920 | 0.000 | 46.833 |
| A5 | 3.000 | 0.000 | 9.000 | 15.000 | 5.400 | 36.960 | 0.000 | 46.194 |
| A6 | 9.000 | 0.000 | 0.000 | 9.000 | 3.600 | 23.040 | 0.000 | 29.730 |
| A7 | 0.000 | 18.000 | 35.000 | 0.000 | 0.000 | 84.800 | 1.325 | 92.657 |
| A8 | 0.000 | 18.000 | 9.000 | 0.000 | 0.000 | 43.200 | 0.675 | 47.203 |
| A9 | 0.000 | 9.000 | 9.000 | 9.000 | 0.000 | 37.440 | 0.585 | 43.307 |
| A10 | 0.000 | 6.000 | 9.000 | 12.000 | 0.000 | 35.520 | 0.555 | 42.008 |
| A11 | 0.000 | 3.000 | 9.000 | 15.000 | 0.000 | 33.600 | 0.525 | 40.709 |
| A12 | 0.000 | 9.000 | 0.000 | 9.000 | 0.000 | 23.040 | 0.360 | 27.572 |

TABLE 5
The results of the chemical stability tests for only an exemplary set of compositions of the present invention.

| | | | | Resistance to electroless |
|---|---|---|---|---|
| Formula | Resistance to | | Resistance to immersion Tin | Nickel/gold (ENIG)Surface |
| Name | Organic solvent | Resistance to soldering | surface finish | finish |
| A1 | Medium-poor | Poor | Poor | Poor |
| A2 | Medium | Medium | Poor | Poor |
| A3 | Excellent | Excellent | Excellent | Excellent |
| A4 | Excellent | Excellent | Excellent | Excellent |
| A5 | Excellent | Excellent | Excellent | Excellent |
| A6 | Good - but phase | Good - but phase | Good- but phase | Good - but phase |
| | separation occurs | separation occurs | separation occurs | separation occurs |
| | between two polymers | between two polymers | between two polymers | between two polymers |
| A7 | Medium-poor | Poor | Poor | Poor |
| A8 | Poor | Poor | Poor | Poor |
| A9 | Good | Good | Medium | Medium |
| A10 | Excellent | Excellent | Excellent | Excellent |
| A11 | Excellent | Excellent | Excellent | Excellent |
| A12 | Good - but phase | Good - but phase | Good - but phase | Good - but phase |
| | separation occurs | separation occurs | separation occurs | separation occurs |
| | between two polymers | between two polymers | between two polymers | between two polymers |

TABLE 6
viscosity comparison between the original ink (1 day after
preparation) and that of aged ink, where the final viscosity
is the viscosity after 7 days at 50° C.

| Formula | Initial viscosity(cps) | Final viscosity(cps) |
|---|---|---|
| Name | at 5000 1/sec | at 5000 1/sec |
| A1 | 13.5 | 18 |
| A2 | 11.5 | 20 |
| A3 | 11.4 | 12.2 |
| A4 | 11.1 | 11.9 |
| A5 | 11.0 | 11.9 |
| A6 | 11.1 | 12.2 |
| A7 | 11 | 11 |
| A8 | 11.1 | 11.3 |
| A9 | 11.4 | 11.7 |
| A10 | 11.3 | 11.5 |
| A11 | 11.4 | 11.9 |
| A12 | 11.1 | 11.9 |

1-50. (canceled)

51. A thermosetting ink formulation, comprising
at least one phenolic resin selected from phenol aldehyde condensates and hydrogenated products thereof, etherified phenol aldehyde condensates and hydrogenated etherified phenol aldehyde condensates, homopolymers and copolymers of alkenyl phenols and hydrogenated products thereof, poly(vinyl phenol) resins and co-polymers thereof, hydrogenated poly(vinyl phenol) resins and co-polymers thereof, polymers comprising phenolic units and non-aromatic cyclic alcohol units and hydrogenated products thereof, and homo-polymers and co-polymers of N-hydroxyphenyl-maleimides;
at least one amino resin selected from melamine monomer or polymer, melamine-formaldehyde resins, benzoguanamine-formaldehyde resins, urea-formaldehyde resins, glycoluril-formaldehyde resins, triazine based amino resins and combinations thereof; and
at least one polyol having at least two hydroxyl groups; said formulation being latent.

52. The formulation according to claim 51, wherein said hydroxyl group is covalently attached to an aliphatic, aromatic, heterocyclic, alicyclic, or a silicone chain or ring.

53. The formulation according to claim 51, wherein said polyol has an OH equivalent weight lower than 600.

54. The formulation according to claim 51, wherein said at least one polyol is selected from diglycidyl ether of bisphenol A (DGEBA), diglycidyl ether of bisphenol F (DGEBF), diglycidyl ether of bisphenol S (DGEBS), cycloaliphatic polyols and ethoxylate thereof, ethoxylated or propoxylated polyhydric alcohols, heterocyclic based polyols, Styrene-Allyl Alcohol (SAA), copolymers of unsaturated aromatic monomer and hydroxyl containing unsaturated monomer.

55. The formulation according to claim 54, wherein said polyol is selected from DGEBA, DGEBF, and DGEBS.

56. The formulation according to claim 51, characterized by a viscosity lower than 50 Cps at a shear rate of 10 to 100,000 sec⁻¹ at a temperature lower than 100° C. and having a surface tension lower than 40 dynes/cm.

57. The formulation according to claim 51, wherein the ratio of the sum of the moles of reactive groups in said phenolic resin and said amino resin to the sum of moles of hydroxyl groups in said polyol and other hydroxyl containing non-volatile compounds in the said formulation is greater than 1.5.

58. The formulation according to claim 51, wherein the mass ratio of said amino resins to said phenolic resins is in the range of 0.01 to 100.

59. The formulation according to claim 51, comprising between about 1-40% of said amino resin, between about 1-40% of said phenolic resin, and between about 1-40% of said polyol, of the total weight of said formulation.

60. The formulation according to claim 51 further comprising at least one pigment or dye, wherein said pigment is selected from titanium dioxide, zinc sulfide, carbon black, Cu-phthalocyanine, benzimidazolone, azo pigments, and metallic pigments and combinations thereof, said pigment is present in an amount between about 1 to 60% of the total weight of said formulation.

61. The formulation according to claim 60, wherein said pigment is or comprising titanium dioxide.

62. The formulation according to claim 51 further comprising at least one mineral filler in an amount between 1-60% of the total weight of the formulation.

63. The formulation according to claim 51, further comprising at least one agent selected from a wetting agent, dispersing agent, antifoam, adhesion promoter, catalyst, inhibitor, and an organic solvent.

64. The formulation according to claim 51, comprising:
a) between about 1-40% of at least one amino resin;
b) between about 1-40% of at least one phenolic resin;
c) between about 1-40% of at least one polyol;
d) between about 1-60% of a pigment or dye;
e) between about 0-60% of at least one mineral filler and
f) between about 5-60% of an organic solvent.

65. The formulation according to claim 51, further comprising at least one blocked acid catalyst, selected from blocked triflic acid, blocked sulfonic acid derivatives, blocked dodecylbenzenesulfonic acid (DDBSA), blocked dinonylnaphthalenedisulfonic acid (DNNDSA), blocked dinonylnaphthalene sulfonic acid (DNNSA), phosphates and phosphonates, and antimony fluorides, wherein said at least one blocked acid catalyst is present in an amount between about 0.01 to 10% of the total weight of the formulation.

66. The formulation according to claim 51, further comprising at least one hydroxyl-group containing unsaturated monomer, which comprises at least one primary or secondary aliphatic hydroxyl group and at least one unsaturated group selected from vinyl, allyl, acryl, methacryl, fumaryl group or any reactive C—C double or triple bond, wherein said at least one hydroxyl-group containing unsaturated monomer is present in an amount between about 1-20% of the total weight of the formulation.

67. The formulation according to claim 51, further comprising unsaturated monomers selected from acrylic acid and methacrylic acid derivatives, acrylate esters of short polyols and polyhydric alcohols, urethane acrylate, acrylate ester of tris-2-hydroxyethyl isocyanurate, acrylate esters of cycloaliphatic diols and polyols, high functionality polyacrylate, allyl ether, and allyl esters.

68. The formulation according to claim 51, further comprising at least one photoinitiator capable of generating free radicals, wherein said at least one photoinitiator is present in an amount between about 0.1-20% of the total weight of the formulation.

69. A thermosetting ink formulation comprising:
5.83% of EPON 1001
5.83% of FB210B60
6.19% of CYMEL 325
2.55% of SB500E50
2.91% of at least one high molecular weight dispersant
45.90% of an organic solvent
0.18% of MDEA, and
30.60% of KRONOS 2310.

70. A thermosetting ink formulation comprising:
3.88% of EPON 1001
1.83% of FB210B60
11.72% of CYMEL 325
2.56% of SB500E50
2.93% of at least one high molecular weight dispersant
46.14% of an organic solvent
0.18% of MDEA, and
30.76% of KRONOS 2310.

71. A method for the manufacture of a thermosetting ink formulation, said method comprising:
(i) mixing at least one amino resin and at least one polyol and at least one phenolic resin, until a clear solution is obtained;
(ii) optionally adding additives selected from wetting agents, dispersing agents, catalysts, inhibitors, defoamers and adhesion promoters;
(iii) adding at least one pigment or dye into said clear solution;
(iv) Optionally adding at least one filler into said clear solution;
(v) dispersing the mixture of step (iv) by means of high shear mixer;
(vi) milling the dispersed mixture of step (iii) until at least 90% of the mixture is able to pass through a 2− or less micron filter; and
(vii) adjusting the viscosity and surface tension of the filtered formulation of step (iv) by adding additional solvents, thus obtaining the desirable thermosetting ink formulation.

72. The method according to claim 71, wherein heat sensitive components selected from phenolic resin, initiators and catalysts, photo-initiators, and the unsaturated reactive compounds, hydroxyl-group comprising unsaturated compounds, and combinations thereof , are introduced after step (vi).

73. A thermosetting ink formulation obtained by the method of claim 71.

74. A thermosetting ink formulation, obtainable by the method of claim 71.

75. A method for ink jet printing, said method comprising:
(i) providing the formulation of claim 51;
(ii) ink-jetting said formulation onto a substrate; and
(iii) curing said ink-jetted formulation under conditions suitable for obtaining a chemically and physically resistant cured print.

76. The method according to claim 75, wherein said curing is achieved by a method selected from IR irradiation, convection oven heating, and any combination thereof.

77. The method according to claim 76, wherein said curing is performed at temperatures lower than 200° C.

78. The method according to claim 75, wherein said substrate is selected from glass, glass fiber reinforced thermosetting laminate, organic fibers reinforced thermosetting laminate, PCB laminate, flexible PCB, polyimide and PCB thereof, ceramics, plastic, metal planes, metallic films, metallic lines and conductors, cured and semi cured photo polymers, metal oxides, and cured and semi cured solder mask.

79. The method according to claim 78, wherein said substrate is a PCB board including any surface feature on its outer layers.

80. The method according to claim 75, wherein said cured print is a legend.
